(19) United States
(12) Patent Application Publication
(10) Pub. No.: US 2025/0364712 A1
(43) Pub. Date: Nov. 27, 2025

(54) WAVEGUIDE DEVICE, AND RADAR DEVICE COMPRISING A WAVEGUIDE DEVICE

(71) Applicant: Robert Bosch GmbH, Stuttgart (DE)

(72) Inventors: Bence Erdei, Vecsés (HU); Daniel Lopez Cuenca, Stuttgart (DE); Istvan Ther, Budapest (HU); Julio Alberto Gonzalez Marin, Stuttgart (DE); Margarida Ribeiro, Braga (PT)

(21) Appl. No.: 19/186,846

(22) Filed: Apr. 23, 2025

(30) Foreign Application Priority Data
May 24, 2024 (DE) 10 2024 204 804.6

(51) Int. Cl. H01P 3/08; G01S 7/02; G01S 7/03; H01Q 1/40

(52) U.S. Cl. CPC H01P 3/081; G01S 7/027; G01S 7/032; H01P 3/088; H01Q 1/405

(57) ABSTRACT

A waveguide device. The waveguide device is mountable on a printed circuit board (PCB) and/or an integrated circuit device (MMIC), and includes: at least one bottom-side carrier, on which a first waveguide layer is arranged or which itself is designed as a first waveguide layer; a plurality of ball contact points, which are arranged in a predetermined pattern on the bottom-side carrier and at least partially surround a first lateral inner region of the first waveguide layer; at least a first top-side carrier, which is arranged in parallel with the bottom-side carrier and at least in regions opposite the first waveguide layer and at least in regions on the ball contact points, wherein at least one emission/incident aperture for radar radiation is present in the first top-side carrier and opposite the first lateral inner region.

### CROSS REFERENCE

The present application claims the benefit under 35 U.S.C. § 119 of German Patent Application No. DE 10 2024 204 804.6 filed on May 24, 2024, which is expressly incorporated herein by reference in its entirety.

### FIELD

The present invention relates to a waveguide device and to a radar device comprising a waveguide device.

### BACKGROUND INFORMATION

Common waveguides for radar solutions in the automotive sector increasingly use microstructures in conjunction with printed circuit board applications since they are characterized by advantageous antenna properties and relatively low cost. For this purpose, waveguide solutions and antennas can be implemented on a top side of a printed circuit board. For example, two injection-molded plastic halves may be metalized and used with or without galvanic contact. Furthermore, multiple metallic layers may be used without galvanic contact. However, in common approaches, the antenna is usually a separate unit and needs to be mounted on a radar printed circuit board. Current market trends show tremendous interest in such technologies.

U.S. Patent Application Publication No. US 2017/084971 A1 describes a waveguide device.

### SUMMARY

The present invention provides a waveguide device according to and a radar device comprising a waveguide device.

Preferred example embodiments and developments of the present invention are disclosed herein.

An idea underlying the present invention is to specify a waveguide device and a radar device comprising a waveguide device, wherein an arrangement of one or more waveguides on a base carrier can be simplified, and the base carrier can be a printed circuit board or a simple metallic conductor layer or conductor carrier.

According to an example embodiment of the present invention, the waveguide device, which is mountable on a printed circuit board and/or an integrated circuit device, comprises at least one bottom-side carrier, on which a first waveguide layer is arranged or which itself is designed as a first waveguide layer; a plurality of ball contact points, which are arranged in a predetermined pattern on the bottom-side carrier and at least in regions surround a first lateral inner region of the first waveguide layer; at least a first top-side carrier, which is arranged in parallel with the bottom-side carrier and at least in regions opposite the first waveguide layer and at least in regions on the ball contact points, wherein at least one emission/incident aperture for radar radiation is present in the first top-side carrier and opposite the first lateral inner region.

The waveguide device may also be used to implement a component as an antenna for a radar application in the automotive sector. The versatility and ease of attachment of the bottom-side carrier in an electronic system (for example, radar application) of a vehicle eliminates the need for an expensive high-frequency substrate/printed circuit board. Such an antenna, as a single component, which comprises the bottom-side carrier and the other elements, can be mounted on a further printed circuit board and connected to and/or mounted on an integrated circuit device (MMIC).

According to an example embodiment of the present invention, the manufacture and application/assembly of the ball contact points can advantageously be implemented with a high-precision BGA (ball grid array) application/method, which can cost-effectively and efficiently be based on a solder paste printing process.

For example, the bottom-side carrier and the first top-side carrier (as well as subsequently the second top-side carrier) may be rectangular (in the lateral direction).

The waveguide device according to an example embodiment of the present invention may advantageously represent a layered (stacked) structure.

The waves can advantageously be guided via the first (and second) waveguide layer and the air between the respectively adjacent carriers of the stack arrangement in the interior of the waveguide device.

According to a preferred embodiment of the waveguide device of the present invention, a distance between the bottom-side carrier and the first top-side carrier is defined by the ball contact points.

According to a preferred embodiment of the waveguide device of the present invention, the distance between the bottom-side carrier and the first top-side carrier is less than or equal to a half wavelength of the radar radiation. A layered structure of the waveguide device according to the present invention differs significantly from the conventional related art.

According to a preferred embodiment of the waveguide device of the present invention, the bottom-side carrier and/or the first top-side carrier comprises a metal carrier, for example comprising copper.

According to a preferred embodiment of the waveguide device of the present invention, the predetermined pattern of the ball contact points comprises a lateral aperture path for radar radiation to be conducted through the first waveguide layer, and/or at least one emission/incident aperture for the radar radiation is present in the first waveguide layer.

According to a preferred embodiment of the waveguide device of the present invention, the waveguide device comprises a second top-side carrier, and a second waveguide layer is arranged on a top side of the first top-side carrier, facing away from the bottom-side carrier, and a further plurality of ball contact points is arranged in a further predetermined pattern on the top side of the first top-side carrier and which ball contact points surround a second lateral inner region of the second waveguide layer at least in regions, and the second top-side carrier is arranged in parallel with the first top-side carrier and at least in regions opposite the second waveguide layer and at least in regions on the further ball contact points, wherein at least one further emission/incident aperture for the radar radiation is present in the second top-side carrier and opposite the second lateral inner region.

For joining the first top-side carrier to the bottom-side carrier, the ball contact points can be arranged on the underside of the first top-side carrier and placed with associated foot points on the top side of the bottom-side carrier. For joining the first top-side carrier to the second top-side carrier (and any further top-side carriers), the ball contact points can be arranged on the underside of the second top-side carrier and placed with associated foot points on the top side of the first top-side carrier. Such stackings can also be continued analogously with further top-side carriers.

According to a preferred embodiment of the waveguide device of the present invention, the bottom-side carrier is formed as a printed circuit board.

According to a preferred embodiment of the waveguide device of the present invention, in a perpendicular projection of the planes in which the first waveguide layer and the second waveguide layer extend, the first waveguide layer and the second waveguide layer partially overlap.

Advantageously, the distance (the height of the ball contact points BGA) between the bottom-side carrier and the first top-side carrier (or between the two top-side carriers) can be reduced almost without limitations. This can also be the case if the (first) waveguide layer is integrated in a substrate. Furthermore, a lateral arrangement of the ball contact points can comprise one or more recesses, for example in the direction from which the waveguide layer is routed, without experiencing significant waveguiding performance limitations.

In the case of an advantageously rectangular design of the bottom-side carrier and of the first and/or second top-side carrier, a sandwich arrangement (possibly with lateral overlap) of these carriers can be achieved at least in regions.

This sandwich arrangement can have an air-filled interior and a flat shape, which can be suitable due to low loss and the possibility of providing complex waveguide paths. The wave can advantageously propagate in air within the waveguide arrangement for a majority of the way. If a printed circuit board is used as a bottom-side carrier or one of the top-side carriers, its loss can be reduced by reducing its thickness or the thickness of the first/second waveguide layer, and incident/emission apertures can be present/produced as laser-cut apertures. The second top-side carrier may be a printed circuit board, which may have a homogeneous and/or continuous top side. Furthermore, frequency-selective layers can also be applied thereto (on its outer top side and/or inner side) or, in a similar way, to the first top-side carrier (or one frequency-selective layer can in each case be applied at the respective location), which frequency-selective layers need not be visible to the outside and can reduce or prevent reflections toward the outside and/or inside. The aforementioned manner of applying the ball contact points can improve or increase their positioning accuracy. Furthermore, no gluing of subcomponents is necessary and any offsets that occur over time can be minimized. Instead of common printed circuit boards, organic materials and components may also be used. For complex waveguide routing of the first and/or second waveguide layers, multiple adjacent sub-rectangles of the bottom-side carrier and/or of the first and second top-side carrier can be implemented next to one another or on top of one another. Bends, splitters (distributors), antenna arrays of the incident/emission apertures, etc. can also be implemented. Advantageously, providing and/or arranging the bottom-side carrier does not require separate processes for arranging it on a printed circuit board. Specific/appropriate positioning of the carriers (the bottom-side carrier, the top-side carriers) can be carried out with a ball-contact-point positioning process (or a process for applying the ball contact points). In this way, manufacturing costs can advantageously be reduced since only one bottom-side carrier (or even this bottom-side carrier itself as only a single layer) needs to be applied to/arranged on a support (printed circuit board or MMIC). For example, the single layer of the bottom-side carrier may be a standard FR-4 PCB material or a simple metal layer/sheet.

When using the second top-side carrier, it itself may be an additional printed circuit board. In this case, a soldering method according to the application with only a first top-side carrier and the ball contact points there can be used.

The multitude of ball contact points can increase mechanical stability of the entire waveguide arrangement, and the method for arranging the ball contact points can reduce corresponding costs and can keep complexity low despite a high number of ball contact points.

According to an example embodiment of the present invention, the waveguide device can furthermore be characterized in that the number of components required can be kept low, which reduces costs and manufacturing expenses.

According to a preferred embodiment of the waveguide device of the present invention, the waveguide device comprises a housing, which forms a cavity in which the arrangement comprising the bottom-side carrier and the first top-side carrier and the second top-side carrier is arranged, wherein the second top-side carrier is formed as a radome with an emission/incident aperture and seals the cavity of the housing in an emission direction/incidence direction.

With the second top-side carrier as a radome, this radome can be integrated into the antenna, which can be represented by the waveguide device, or a separate radome can be connected to the stack arrangement. In this case, the radome can comprise a plastic and protect the waveguide device from external influences and also cap it.

According to an example embodiment of the present invention, the radar device comprises at least one printed circuit board and/or an integrated circuit device and at least one waveguide device according to the present invention arranged thereon.

For example, the radar device may be used for a 60 GHz radar. Furthermore, a radome component can seal the waveguide device toward the outside and in the emission direction, wherein the waveguide device may also comprise an organic material.

The advantages of the waveguide device can advantageously also relate to the radar device and to a method for manufacturing and applying it.

Further features and advantages of embodiments of the present invention arise from the following description with reference to the figures.

### BRIEF DESCRIPTION OF THE DRAWINGS

The present invention is explained in greater detail below with reference to the exemplary embodiments shown in the schematic figures.

FIG. 1 shows a schematic illustration of a waveguide device according to an exemplary embodiment of the present invention.

FIG. 2A shows a schematic plan view of an underside of the first top-side carrier for a waveguide device according to an exemplary embodiment of the present invention.

FIG. 2B shows a schematic plan view of a bottom-side carrier for a waveguide device according to an exemplary embodiment of the present invention.

FIG. 3 shows a schematic plan view of a second top-side carrier for a waveguide device according to an exemplary embodiment of the present invention.

FIG. 4 shows a schematic illustration of a waveguide device in a radar device according to an exemplary embodiment of the present invention.

Identical reference signs in the figures denote identical or functionally identical elements.

### DETAILED DESCRIPTION OF EXAMPLE EMBODIMENTS

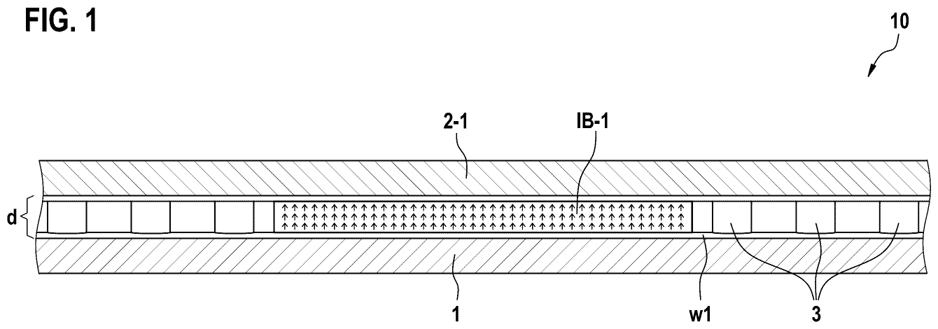

FIG. 1 shows a schematic illustration of a waveguide device according to an exemplary embodiment of the present invention (in a sectional view).

The waveguide device 10, which is mountable on a printed circuit board and/or an integrated circuit device, comprises at least one bottom-side carrier 1, on which a first waveguide layer w1 is arranged or which itself is designed as a first waveguide layer w1; a plurality of ball contact points 3, which are arranged in a predetermined pattern on the bottom-side carrier 1 and at least in regions surround a first lateral inner region IB-1 of the first waveguide layer w1; at least a first top-side carrier 2-1, which is arranged in parallel with the bottom-side carrier 1 and at least in regions opposite the first waveguide layer w1 and at least in regions on the ball contact points 3. A distance d between the bottom-side carrier 1 and the first top-side carrier 2-1 can be defined by the ball contact points 3.

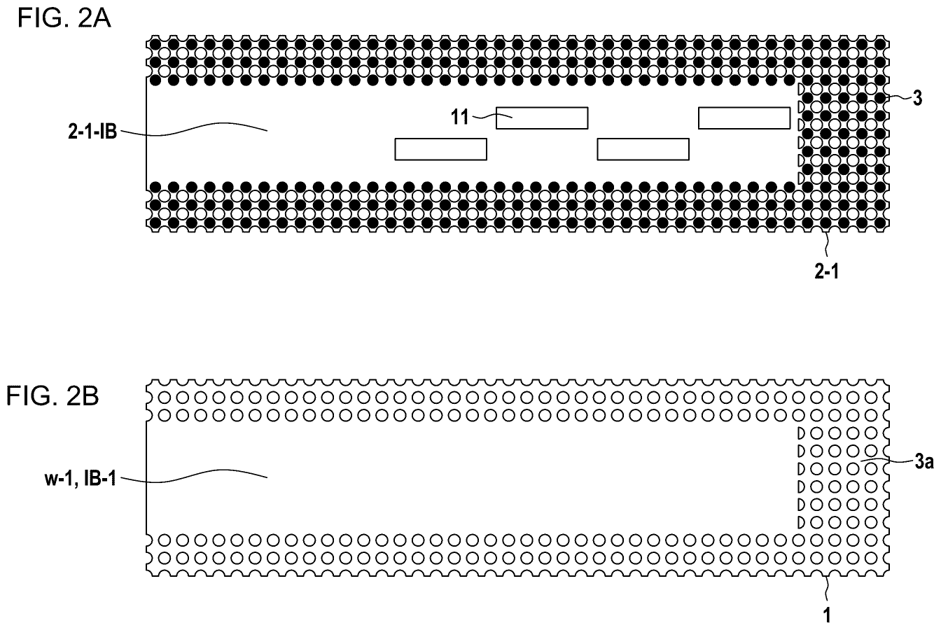

FIG. 2A shows a schematic plan view of a first top-side carrier for a waveguide device according to an exemplary embodiment of the present invention.

The first top-side carrier 2-1 is shown with an inner carrier region 2-1-IB from the underside, for example is metallically coated or even itself represents the (e.g., metallic) material of the first top-side carrier 2-1 that may be opposite the inner region IB-1 of the first waveguide layer w1 of FIG. 2B when they are opposite one another in a sandwich arrangement. For example, the inner carrier region 2-1-IB as well as the first waveguide layer w1 may extend to the left to the edge of the rectangular arrangement of the first top-side carrier 2-1 or the bottom-side carrier 1. In this case, the wave from this direction can be conducted via this first top-side carrier 2-1 or bottom-side carrier 1 from the lateral side laterally inward. The specified pattern of the ball contact points 3 is arranged such that this lateral side routing of the carrier inner region 2-1-IB remains free of the ball contact points 3 (located on the underside of the first top-side carrier 2-1), and thus open, and is surrounded by the ball contact points 3 on the other lateral sides. The ball contact points 3 shield the waves downstream of the inner carrier region 2-1-IB. In the inner carrier region 2-1-IB, emission/incident aperture 11 [sic]¹ for radar radiation can be arranged in (and pass through) the first top-side carrier 2-1 according to a predetermined pattern. ¹[Translator's note: Subject/verb mismatch in the German, “aperture 11” should possibly be plural: “apertures 11”.]

FIG. 2B shows a schematic plan view of a bottom-side carrier for a waveguide device according to an exemplary embodiment of the present invention.

In comparison to FIG. 2A, the bottom-side carrier 1 can have the corresponding antisymmetry for its sandwich arrangement (for example, according to FIG. 1). In this case, the first lateral inner region IB-1 can be surrounded by a pattern of foot points 3a on the bottom-side carrier 1 (the top side thereof), which foot points can be provided for the placement of the ball contact points 3 of the first top carrier 2-1. In a projection from a perpendicular direction onto the first lateral inner region IB-1 and the inner carrier region 2-1-IB, these regions may be congruent. The wave can thus be conducted from the lateral aperture (left in a region without ball contact points) into the first lateral inner region IB-1 (also through the air above it) and emitted via the emission apertures 11 (or, vice versa, received and conducted away).

Or can be conducted into a superjacent intermediate region between two top-side carriers.

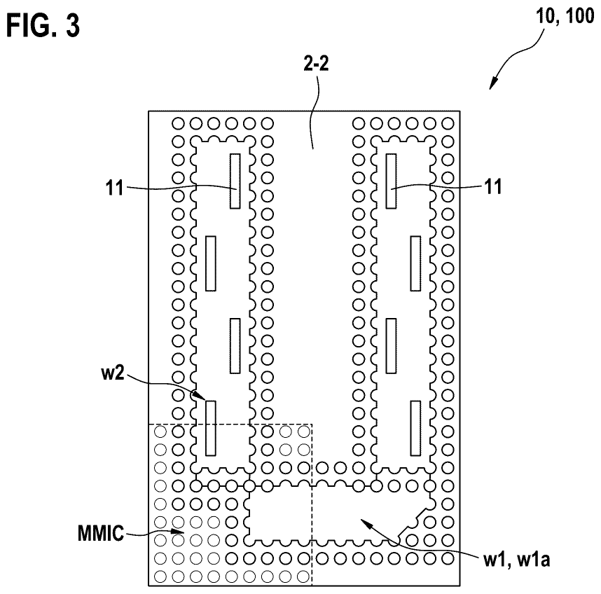

FIG. 3 shows a schematic plan view of a second top-side carrier for a waveguide device according to an exemplary embodiment of the present invention.

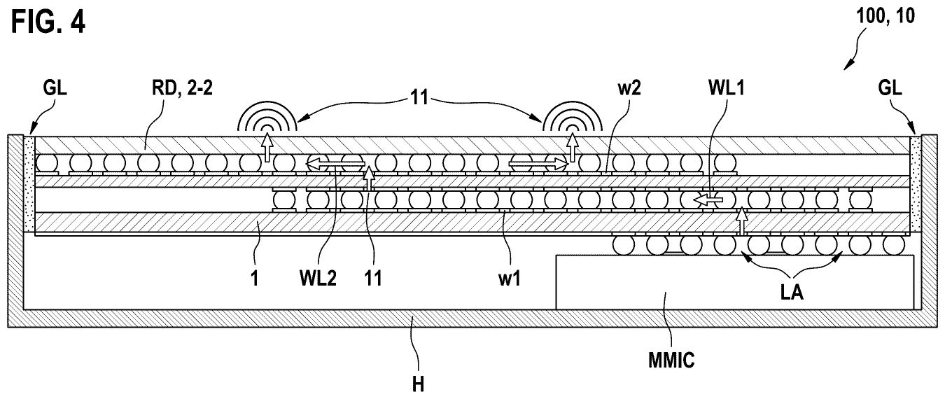

With the sandwich arrangement (FIG. 4), a more complex branching of the waveguide routing can be achieved than if only a first top-side carrier is used (FIG. 1). As shown in FIG. 3, multiple regions with emission/incident aperture 11 [sic]² for radar radiation (array) may be present on the emission side/incidence side of a second top-side carrier 2-2. FIG. 3 shows a projection from a direction perpendicular to the emission side through the sandwich arrangement of the waveguide device 10 (radar device 100). It can be seen that the waves can be conducted via a second waveguide layer w2 to the emission/incident apertures 11 on the top side and, in the interior of the waveguide device 10, via the first waveguide layer w1 and any intermediate conductor layers w1a to the second waveguide layer w2 (and to its intermediate apertures 11 between the first top-side carriers (not shown)). Likewise, the wave can already be conducted from the MMIC to the first waveguide layer on the underside and can overcome the bottom-side carrier through corresponding through-openings (not shown) and reach the first waveguide layer w1 (and vice versa). ²[Translator's note: “aperture 11” should possibly be plural: “apertures 11”.]

FIG. 4 shows a schematic illustration of a waveguide device in a radar device according to an exemplary embodiment of the present invention.

The second top-side carrier 2-2 can be arranged with further ball contact points 3 and a corresponding lateral pattern thereof on the first top-side carrier 2-1. A second waveguide layer w2 can be arranged on a top side of the first top-side carrier 2-1, facing away from the bottom-side carrier 1. In a sandwich arrangement/stack arrangement, the second top-side carrier 2-2 can be arranged in parallel with the first top-side carrier 2-1 and at least in regions opposite the second waveguide layer w2 and at least in regions on the further ball contact points 3, wherein at least one further emission/incident aperture 11 can be introduced into the second top-side carrier 2-2 on the top side for the radar radiation and a wave can be received or emitted via said aperture.

Through bottom emission/incident apertures 11 in the first top-side carrier 2-1, the first wave WL1 (conducted between the bottom-side carrier 1 and the first top-side carrier 2-1) can reach a level higher in the stack arrangement and can be referred to there as the second wave WL2, which can be conducted laterally from the MMIC in more complex paths and can subsequently be emitted via top emission/incident apertures 11 in the second top-side carrier 2-2 or through a transparent radome (correspondingly for receiving).

In a perpendicular projection of the planes in which the first waveguide layer w1 and the second waveguide layer w2 extend, the first waveguide layer w1 and the second waveguide layer w2 can partially overlap.

The radar device 100 can comprise a housing H, which forms a cavity in which the arrangement, comprising the bottom-side carrier 1 and the first top-side carrier 2-1, and the second top-side carrier 2-2 can be arranged, wherein the second top-side carrier 2-2 can be formed as a radome RD with the emission/incident aperture 11 [sic]³ and can seal the cavity of the housing H in an emission direction/incidence direction. The radome RD and at least one of the top-side carrier and the bottom-side carrier can be glued/soldered on the lateral sides with an adhesive/solder to the housing H (GL shown as connection) and the radome RD can seal the cavity flush with the housing H on the top side. The bottom-side carrier 1 can be placed on a printed circuit board or on an integrated circuit device MMIC, and receiving and/or emitting the radar radiation through the stacked waveguide device can be offset laterally from this MMIC. ³[Translator's note: Subject/verb mismatch in the German, “aperture 11” should probably be plural: “apertures 11”.]

The first wave WL1 and the second wave WL2 can advantageously be guided via the first (and second) waveguide layer and the air between the respectively adjacent carriers of the stack arrangement in the interior of the waveguide device.

The radome RD can be solid, water-repellent, and can seal the cavity in a watertight manner and can be transparent to radar radiation and/or have corresponding emission/incident apertures 11 and comprise a printed circuit board material, glass, ceramic, or other applicable substances.

Advantageously, very small tolerances may be present between the antenna (the first top-side carrier) and the radome RD, and the gluing position may, for example, affect only the antenna position, less so the antenna performance. According to the arrangement mentioned, an additional absorbent material can be dispensed with in order to achieve internal waveguiding between the radome and the top-side carrier according to the corresponding specification. The radome can be used as an additional heat sink for thermal optimization, and an elevation profile can be advantageously reduced.

The launcher LA in the MMIC can be used to couple energy into/out of the wave path WL1.

Although the present invention has been completely described above with reference to the preferred exemplary embodiment, it is not limited thereto but can be modified in many ways.

What is claimed is:

1. A waveguide device, which is mountable on a printed circuit board (PCB) and/or an integrated circuit device (MMIC), the waveguide device comprising:
at least one bottom-side carrier, on which a first waveguide layer is arranged or which itself is configured as the first waveguide layer;
a plurality of ball contact points, which are arranged in a predetermined pattern on the bottom-side carrier and surround a first lateral inner region of the first waveguide layer at least in regions; and
at least a first top-side carrier, which is arranged: in parallel with the bottom-side carrier and, at least in regions, opposite the first waveguide layer and, at least in regions, on the ball contact points, wherein at least one emission/incident aperture for radar radiation is present in the first top-side carrier and opposite the first lateral inner region.

2. The waveguide device according to claim 1, wherein a distance between the bottom-side carrier and the first top-side carrier is defined by the ball contact points.

3. The waveguide device according to claim 2, wherein the distance between the bottom-side carrier and the first top-side carrier is less than or equal to a half wavelength of the radar radiation.

4. The waveguide device according to claim 1, wherein the bottom-side carrier and/or the first top-side carrier is a metal carrier.

5. The waveguide device according to claim 1, wherein the predetermined pattern of the ball contact points includes a lateral aperture path for radar radiation to be conducted through the first waveguide layer and/or at least one emission/incident aperture for the radar radiation is present in the first waveguide layer.

6. The waveguide device according to claim 1, wherein a second top-side carrier, and a second waveguide layer is arranged on a top side of the first top-side carrier, facing away from the bottom-side carrier, and a further plurality of ball contact points is arranged on the top side of the first top-side carrier, and the further ball contact points are arranged in a further predetermined pattern and surround a second lateral inner region of the second waveguide layer at least in regions, and the second top-side carrier is arranged: in parallel with the first top-side carrier and, at least in regions, opposite the second waveguide layer and, at least in regions, on the further ball contact points, wherein at least one further emission/incident aperture for the radar radiation is present in the second top-side carrier and opposite the second lateral inner region.

7. The waveguide device according to claim 1, wherein the bottom-side carrier is a printed circuit board.

8. The waveguide device according to claim 6, wherein, in a perpendicular projection of planes in which the first waveguide layer and the second waveguide layer extend, the first waveguide layer and the second waveguide layer partially overlap.

9. The waveguide device according to claim 6, further comprising a housing, which forms a cavity in which an arrangement comprising the bottom-side carrier and the first top-side carrier and the second top-side carrier is arranged, wherein the second top-side carrier is a radome with emission/incident apertures and seals the cavity of the housing in an emission direction/incidence direction.

10. A radar device, comprising:
at least one printed circuit board and/or an integrated circuit device; and
at least one waveguide device arranged on the at least one printed circuit board and/or the integrated circuit device, the waveguide device including:
at least one bottom-side carrier, on which a first waveguide layer is arranged or which itself is configured as the first waveguide layer,
a plurality of ball contact points, which are arranged in a predetermined pattern on the bottom-side carrier and surround a first lateral inner region of the first waveguide layer at least in regions, and
at least a first top-side carrier, which is arranged: in parallel with the bottom-side carrier and, at least in regions, opposite the first waveguide layer and, at least in regions, on the ball contact points, wherein at least one emission/incident aperture for radar radiation is present in the first top-side carrier and opposite the first lateral inner region.
